(19) United States
(12) Patent Application Publication
(10) Pub. No.: US 2006/0294230 A1
(43) Pub. Date: Dec. 28, 2006

(54) Information processing apparatus and connection control method for the apparatus

(75) Inventor: Nobuaki Takasu, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/472,446

(22) Filed: Jun. 22, 2006

(30) Foreign Application Priority Data
Jun. 23, 2005 (JP) 2005-183514

(51) Int. Cl. G06F 15/173

(52) U.S. Cl. 709/224

(57) ABSTRACT

According to one embodiment, an information processing apparatus includes a wireless communication unit configured to transmit and receive data via a wireless communication path to and from an external device, a monitoring unit configured to monitor a state of wireless communication with the external device, and a control unit configured to start a process of disconnecting the wireless communication with the external device, when a predetermined wireless communication state is detected by monitoring of the monitoring unit.

### CROSS-REFERENCE TO RELATED APPLICATIONS

This application is based upon and claims the benefit of priority from Japanese Patent Application No. 2005-183514, filed Jun. 23, 2005, the entire contents of which are incorporated herein by reference.

### BACKGROUND

1. Field

One embodiment of the invention relates to a technology for controlling connection of external devices in an information processing apparatus which is wirelessly connected to external devices such as, for example, a hard disk drive unit.

2. Description of the Related Art

In recent years, notebook personal computers which can be driven by batteries and are easy to carry with have been broadly popularized. In many of such notebook computers, only minimum necessary resources are installed in a computer main unit, and other resources can be connected as external devices as needed for the purpose of reduction in size and weight. It has grown popular in recent notebook computers to have a so-called Plug-and-Play function capable of executing connection and disconnection of the external devices during a system is in operation.

Recently, wireless communication functions such as, for example, Bluetooth(R) are included as standard equipment, which can connect external devices without any cable as needed in operation of a system, and therefore, the usability thereof has been improved spectacularly. Data transmission and reception via wireless communication is influenced by its surroundings at different times as compared with data transmission and reception via wire communication. Accordingly, various communication control methods have been proposed, in which, for example, even if wireless communication is made temporarily impossible, data transmission and reception which has been in execution is resumed after the wireless communication is recovered to an available state without a user being made aware of the disconnection (refer to, for example, Jpn. Pat. Appln. KOKAI Publication No. 8-340308).

Here, suppose a case in which a user of a notebook computer having a Plug-and-Play function and a wireless communication function moves in a direction getting away from an external device while carrying the computer in mid-flow as an application program executes data transmission and reception to and from the external device wirelessly connected thereto. In such a case, in order to avoid a data loss in the process of transmission and reception, it is prefer to start/complete a proper process of disconnecting wireless communication with the external devices which is called Hot-Unplug process or the like before the connection is unexpectedly disconnected.

However, in the past, reviewing has been made on various mechanisms for assuming the appearance as if data transmission and reception is continuously executed without a user being made aware of disconnection of a connection, but an idea has not existed that a process of disconnecting a connection is actively started (for data integrity) when it is brought under certain situations.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an information processing system according to one embodiment of the present invention;

FIG. 2 is an exemplary radio intensity graph expressing transitions of radio field intensity which is detected by a wireless communication module in the embodiment;

FIG. 3 is an exemplary flowchart showing a first operational procedure of control of wireless communication with a wireless storage device, the procedure being executed by a communication control program in the embodiment;

FIG. 4 is an exemplary flowchart showing a second operational procedure of control of wireless communication with a wireless storage device, the procedure being executed by a communication control program in the embodiment; and

FIG. 5 is an exemplary block diagram of an information processing system according to one modified example of the embodiment.

### DETAILED DESCRIPTION

Various embodiments according to the invention will be described hereinafter with reference to the accompanying drawings. In general, according to one embodiment of the invention, an information processing apparatus includes a wireless communication unit configured to transmit and receive data via a wireless communication path to and from an external device, a monitoring unit configured to monitor a state of wireless communication with the external device, and a control unit configured to start a process of disconnecting the wireless communication with the external device, when a predetermined wireless communication state is detected by monitoring of the monitoring unit.

FIG. 1 is an exemplary block diagram of an information processing system according to one embodiment of the invention.

As shown in FIG. 1, the information processing system of the present embodiment is configured by, for example, a notebook personal computer (PC) 10, and a wireless storage device 20 which is wirelessly connected to the PC 10 as needed.

The PC 10 has a CPU 11, a chipset 12, a memory 13, a hard disk drive unit (HDD) 14, a keyboard controller 15, a display controller 16, and a wireless communication module 17.

The CPU 11 is a processor which manages overall control of the PC 10, and makes a control to execute various programs such as an operating system, utility programs, and application programs which are stored in the memory 13. The chipset 12 is a circuit which relays communication among the CPU 11 and the other respective units. The memory 13 is a storage unit serving as a main memory of the PC 10, and the various programs executed by the CPU 11 and various data used for these programs are stored in the memory 13. As one of these programs, there is a communication control program 100 which controls wireless communication with the wireless storage device 20. On the other hand, the HDD 14 is a storage unit serving as an external memory of the PC 10, and stores various programs and various data in a large quantity as an auxiliary device of the memory 13.

In addition, the keyboard controller 15 manages the input side of a user interface provided by the PC 10, and transmits operations of a keyboard or a mouse to the CPU 11. On the other hand, the display controller 16 manages the output side of the user interface provided by the PC 10, and makes a control to display screen data prepared by the CPU 11 on a display. Then, the wireless communication module 17 executes wireless communication according to, for example, Bluetooth(R) standard. The wireless communication module 17 has a function of detecting radio field intensity and giving notice thereof to the communication control program 100.

On the other hand, the wireless storage device 20 has a wireless communication module 21, a bridge chip 22, and an HDD 23.

The wireless communication module 21 has a wireless communication function which is equivalent to that of the wireless communication module 17 of the PC 10. The bridge chip 22 is a circuit which relays communication between the wireless communication module 21 and the HDD 23. A read/write request of data from the PC 10 to the wireless storage device 20 is converted into read/write request control with respect to the HDD 23 by the bridge chip 22. Namely, the PC 10 can execute read/write of data without having a consciousness of a connection mode or the like of the HDD 23. Then, the HDD 23 is a storage unit serving as an external memory of the PC 10, and stores various programs and various data in a large quantity as an auxiliary device of the memory 13, in the same manner as the HDD 14 of the PC 10.

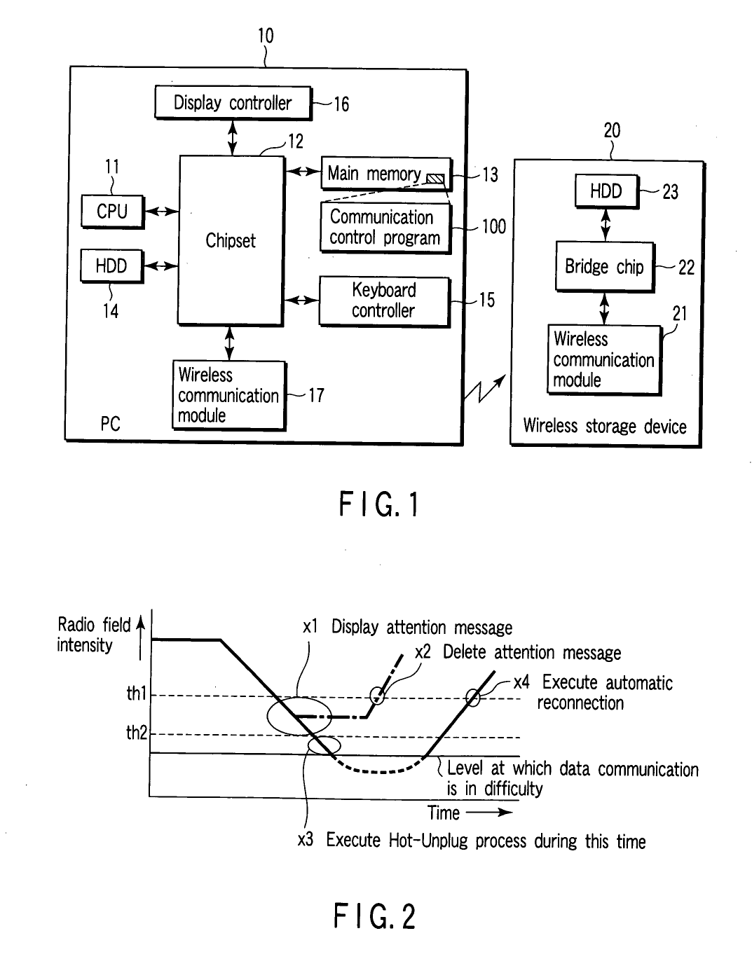

Wireless communication with the wireless storage device 20 by the PC 10 in the information processing system of the embodiment having such a configuration is, as described above, controlled by the communication control program 100 which is stored in the memory 13 to be execute by the CPU 11. Next, a process of automatically disconnecting the wireless storage device 20, the process being executed by the communication control program 100, will be described with reference to FIG. 2. FIG. 2 is an exemplary radio intensity graph expressing transitions of radio field intensity which is detected by the wireless communication module 17 of the PC 10. Note that the communication control program 100 also has a function capable of connecting and disconnecting the wireless storage device 20 which is connected via the wireless communication module 17 in operation of the system, i.e., of causing an operating system to recognize as if the wireless storage device 20 is an external device corresponding to Plug-and-Play.

Now, suppose that, when the wireless communication module 17 is detecting radio field intensity which is stable at high level, radio field intensity detected by the wireless communication module 17 starts to decline gradually due to, for example, a user getting away from the wireless storage device 20 while carrying the PC 10. When radio field intensity declines, the performance in read/write of data with respect to the wireless storage device 20 deteriorates. However, in many cases, a user does not become aware of the deterioration in the performance in read/write of data.

Then, when radio field intensity detected by the wireless communication module 17 is made less than a first threshold value (th1), the communication control program 100 executes output of a message for calling attention to a fact that there is in danger of breaking down due to deterioration in the performance in read/write of data or disconnection by utilizing, for example, a pop-up message function of an operation system or the like, via the display controller 16 (x1 in FIG. 2).

Thereafter, for example, the user who carries the PC 10 returns to the vicinity of the wireless storage device 20 so as to response to the message, whereby radio field intensity detected by the wireless communication module 17 starts to rise, and is recovered to be a first threshold value (th1) or greater. Then, the communication control program 100 stops outputting the message (x2 in FIG. 2).

On the other hand, when, even after the message is outputted, radio field intensity detected by the wireless communication module 17 continues to decline, and is further made less than a second threshold value (th2) immediately before a level at which data communication is difficult, the communication control program 100 issues a request to disconnect the wireless storage device 20 in operation of the system, which is called a safety removable (Hot-Unplug) request or the like, to the operating system. The operating system which has received this request to disconnect stops the read/write of data in a safety timing, and starts a procedure for disconnection of the wireless storage device 20 (x3 in FIG. 2).

In this way, in the information processing system of the embodiment which actively starts a process of disconnecting the wireless storage device 20 by detecting radio field intensity, it can be avoided that data is lost, the system becomes dysfunctional, or the like due to unexpected disconnection by a decline in radio field intensity.

The communication control program 100 continues to monitor radio field intensity detected by the wireless communication module 17 even after disconnecting the wireless storage device 20. Then, when radio field intensity detected by the wireless communication module 17 recovers to be a first threshold value (th1) or greater, the communication control program 100 requires to the operating system reconnection of the wireless storage device 20 in the same setting in the previous connection (x4 in FIG. 2). As a consequence, read/write of data from/into the wireless storage device 20 can be restarted without a reconnecting operation or a resetting operation by hand.

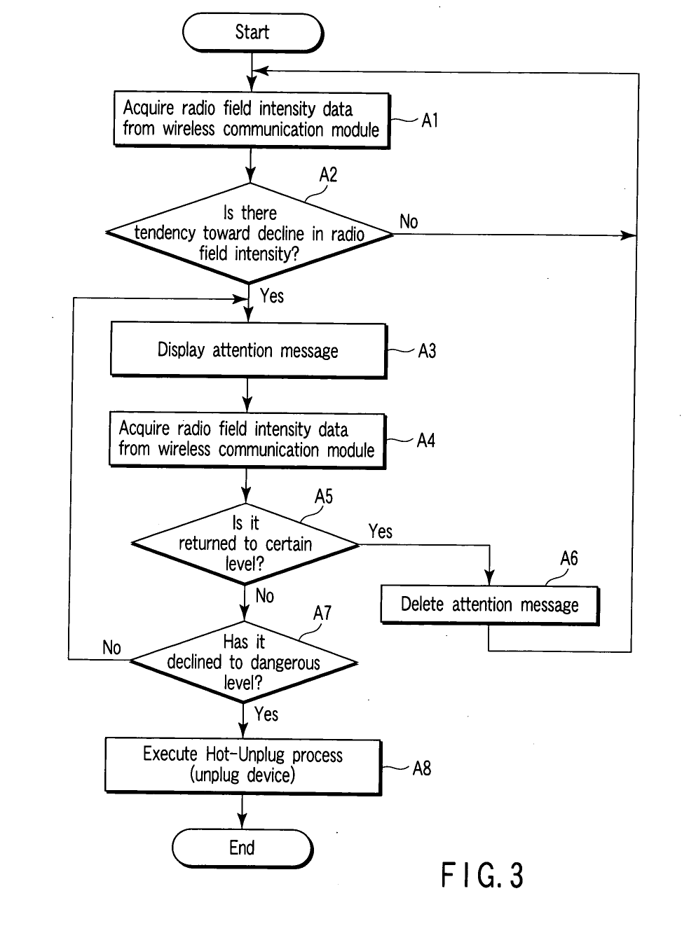

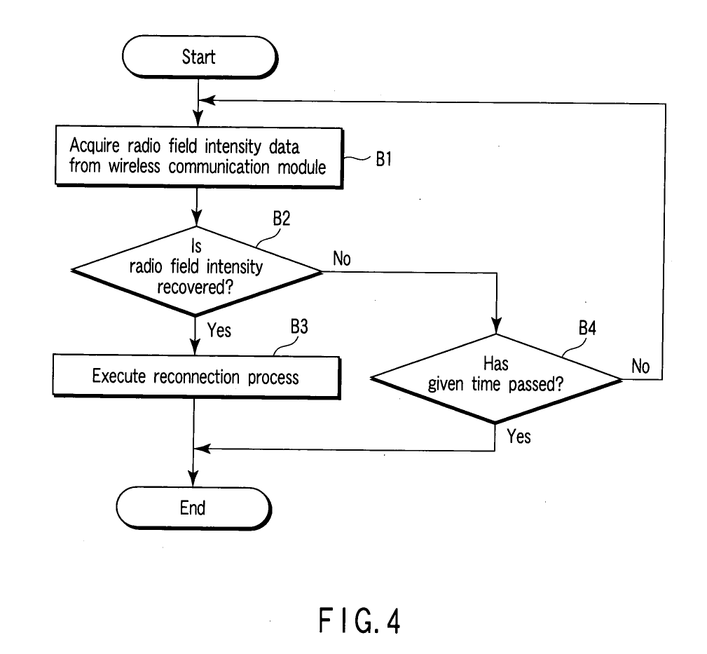

FIGS. 3 and 4 are exemplary flowcharts showing operational procedures for controlling wireless communication with the wireless storage device 20, the procedures being executed by the communication control program 100.

When the communication control program 100 acquires radio field intensity data from the wireless communication module 17 (block A1 in FIG. 3), the communication control program 100 determines whether or not radio field intensity tends to decline (block A2 in FIG. 3). If there is a tendency toward a decline in radio field intensity (YES in block A3 in FIG. 3), the communication control program 100 displays a message for calling attention via the display controller 16 (block A4 in FIG. 3).

After this attention message is outputted, the communication control program 100 acquires radio field intensity data from the wireless communication module 17 (block A4 in FIG. 3), and checks whether or not radio field intensity is recovered to a certain level (block A5 in FIG. 3). If radio field intensity is recovered (YES in block A5 in FIG. 3), the communication control program 100 stops outputting the attention message via the display controller 16 (block A6 in FIG. 3). On the other hand, when radio field intensity does not recover to a certain level even after the attention message (NO in block A5 in FIG. 3), and further declines to a dangerous level (YES in block A7 in FIG. 3), the communication control program 100 starts a process of disconnecting the wireless storage device 20 (block A8 in FIG. 3).

In addition, even after the wireless storage device is disconnected, the communication control program 100 acquires radio field intensity data from the wireless communication module 17 (block B1 in FIG. 4). If radio field intensity is recovered to a certain level (YES in block B2 in FIG. 4), the communication control program 100 executes reconnection of the wireless storage device 20 (block B3 in FIG. 4). On the other hand, when radio field intensity does not recover to a certain level (NO in block B2 in FIG. 4), the communication control program 100 repeats the processings on and after block B1 in FIG. 4 after standing ready for a given time (block B4 in FIG. 4).

In the above description, the example has been described in which the communication control program 100 acquires radio field intensity detected by the-wireless communication module 17, and makes a control such as actively starting a procedure for disconnecting the wireless storage device 20 on the basis of the acquired radio field intensity, and the like. However, a standard for determining whether or not a function of read/write of data via wireless communication can be maintained is not necessarily limited to radio field intensity. For example, it is easy to modify the example such that the wireless communication module 17 is made to detect a communication speed in data transmission and reception, an error rate in data transmission and reception, a throughput in data transmission and reception, and the like, and that control is made on the basis of a detected value.

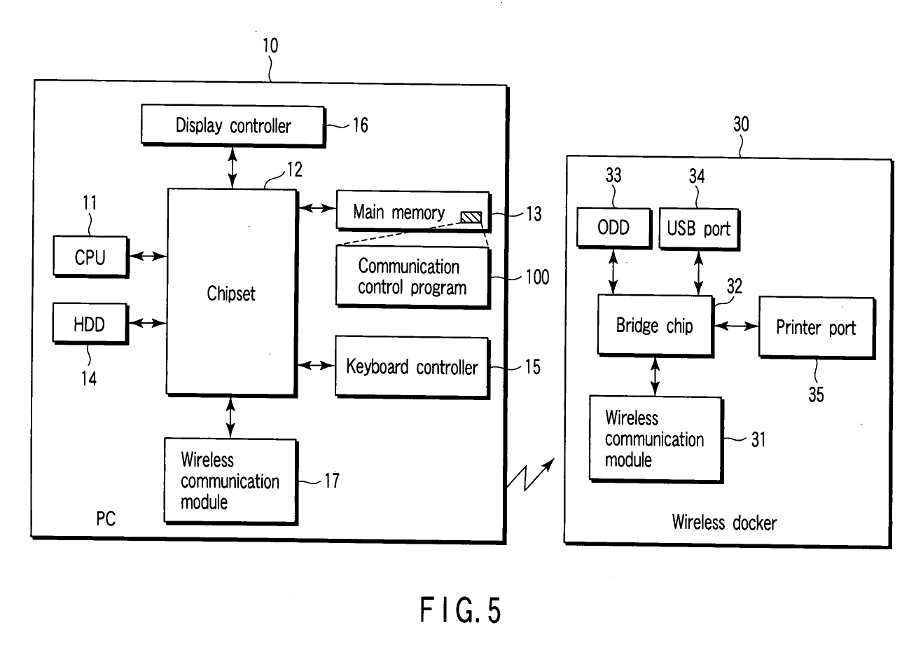

Moreover, a destination to be wirelessly connected to the PC 10 targeted for control by the communication control program 100 is not limited to the wireless storage device 20 having the HDD 23 installed therein. Needless to say, for example, a wireless docker 30 into which an optical magnetic disk driving unit (ODD) 33, a USB port 34, and a printer port 35 are installed as shown in FIG. 5, and the like can be applied.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a wireless communication unit configured to transmit and receive data via a wireless communication path to and from an external device;
a monitoring unit configured to monitor a state of wireless communication with the external device; and
a control unit configured to start a process of disconnecting the wireless communication with the external device, when a predetermined wireless communication state is detected by monitoring of the monitoring unit.

2. The information processing apparatus according to claim 1, wherein the control unit starts the process of disconnecting the wireless communication with the external device when radio field intensity at the time of wireless communication is made less than a predetermined value.

3. The information processing apparatus according to claim 1, wherein the control unit starts the process of disconnecting the wireless communication with the external device when a communication speed value at the time of wireless communication is made less than a predetermined value.

4. The information processing apparatus according to claim 1, wherein the control unit starts the process of disconnecting the wireless communication with the external device when an error rate value at the time of wireless communication is made less than a predetermined value.

5. The information processing apparatus according to claim 1, wherein the control unit starts the process of disconnecting the wireless communication with the external device when a throughput value at the time of wireless communication is made less than a predetermined value.

6. The information processing apparatus according to claim 1, wherein the control unit executes a process of connecting the wireless communication with the external device when a recovery from the predetermined wireless communication state is detected by monitoring of the monitoring means after the process of disconnecting the wireless communication with the external device is completed.

7. The information processing apparatus according to claim 1, wherein the control unit outputs a message for calling attention to a user when a state of wireless communication at a preliminary step toward the predetermined wireless communication state is detected by monitoring of the monitoring unit.

8. The information processing apparatus according to claim 7, wherein the control unit stops outputting the message when a recovery from the state of wireless communication at a preliminary step toward the predetermined wireless communication state is detected by monitoring of the monitoring unit after the message is outputted.

9. A connection control method for an information processing apparatus which transmits and receives data via a wireless communication path to and from an external device, comprising:
monitoring a state of wireless communication with the external device; and
starting a process of disconnecting wireless communication with the external device when a predetermined wireless communication state is detected by the monitoring.

10. The connection control method according to claim 9, wherein the starting a process of disconnecting starts a process of disconnecting the wireless communication with the external device when radio field intensity at the time of wireless communication is made less than a predetermined value.

11. The connection control method according to claim 9, further comprising executing a process of connecting the wireless communication with the external device when a recovery from the predetermined wireless communication state is detected by monitoring after the process of disconnecting the wireless communication with the external device is completed.

12. The connection control method according to claim 9, further comprising outputting a message for calling attention to a user when a state of wireless communication at a preliminary step toward the predetermined wireless communication state is detected by the monitoring.

13. The connection control method according to claim 12, further comprising stopping outputting the message when a recovery from the state of wireless communication at a preliminary step toward the predetermined wireless communication state is detected by the monitoring after the message is outputted.
